(19) United States
(12) Patent Application Publication
(10) Pub. No.: US 2008/0175005 A1
(43) Pub. Date: Jul. 24, 2008

(54) INFLATABLE DECORATIVE COVERINGS FOR LIGHTING DEVICES

(75) Inventors: Gary E. Kellmann, St. Charles, MO (US); Timothy John Henderson, Hong Kong Island (HK)

Correspondence Address: HARNESS, DICKEY, & PIERCE, P.L.C, 7700 Bonhomme, Suite 400, ST. LOUIS, MO, 63105, US

(73) Assignee: Instant Impact Innovations Ltd., Hong Kong (CN)

(21) Appl. No.: 11/626,279

(22) Filed: Jan. 23, 2007

(51) Int. Cl. F21V 1/06

(52) U.S. Cl. 362/352

(57) ABSTRACT

An inflatable decorative covering for decorating a lighting device is removably attachable to the lighting device. The covering generally includes a decorative exterior portion and an inflatable interior portion disposed substantially within the exterior portion. The interior portion defines a passage configured for receiving at least a portion of the lighting device therein. The interior portion also has a first deflated configuration in which the interior portion may be positioned to cover the lighting device with at least a portion of the lighting device within the passage, and a second inflated configuration whereby when the interior portion is inflated, the exterior portion may be illuminated by light emitted from a light source of the lighting device thereby highlighting an object that the exterior portion is configured to resemble. In some embodiments, the exterior portion may be integrally formed with the interior portion.

### FIELD

The present disclosure relates generally to ornamental or decorative devices for use with illumination devices, and more particularly to inflatable decorative coverings for installation to lighting devices.

### BACKGROUND

The statements in this section merely provide background information related to the present disclosure and may not constitute prior art.

Ornamental and decorative devices are commonly used to decorate residential and commercial buildings in accordance with a desired theme. For example, during holiday seasons, buildings may be decorated with temporary decorations depicting snowmen, etc. or with temporary multi-colored lights to promote a festive holiday atmosphere. Temporary decorations may also be used during other selected times of the year to accommodate a desired temporary theme. Alternatively, permanent decorations may be used for themes other than holiday or temporary themes. For example, businesses may use colored lights to draw attention to services or products, or sporting events may use various ball-shaped decorations (e.g., a baseball) to promote games.

### SUMMARY

According to various aspects, exemplary embodiments are disclosed of inflatable decorative coverings that may be used for decorating a lighting device with a particular theme or motif. In one exemplary embodiment, an inflatable decorative covering is attachable to a lighting device for decorating the lighting device in accordance with a theme. In this particular embodiment, the inflatable decorative covering generally includes an exterior portion configured to resemble an object. The inflatable decorative covering also includes an interior portion disposed substantially within the exterior portion and defining a passage in the exterior portion. The interior portion being inflatable and having a first deflated configuration and a second inflated configuration. In the first deflated configuration, the decorative covering may be positioned to cover the lighting device with at least a portion of the lighting device within the passage. In the second inflated configuration, the exterior portion may be illuminated by light emitted from a light source of the lighting device thereby highlighting the object that the exterior portion resembles.

In another exemplary embodiment, an inflatable apparatus configured to resemble an object related to a theme for decorating a lighting device generally comprises an inflatable portion configured for installation over the lighting device.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

FIG. 1 is a perspective of an exemplary embodiment of a decorative covering installed to a lighting device;

FIG. 2 is a side elevation thereof;

FIG. 3 is a top plan thereof;

FIG. 4 is the side elevation of FIG. 2 with part of the decorative covering removed to illustrate the covering installed to the lighting device;

FIG. 5 is an exploded perspective of the decorative covering and lighting device;

FIG. 6 is a perspective of a bladder of an interior portion of the decorative covering in a generally inflated configuration and illustrating a generally frusto-conical end of the bladder;

FIG. 7 is an elevation of the bladder illustrating an outer surface of the bladder;

FIG. 8 is an elevation of the bladder illustrating a side surface;

FIG. 9 is a top plan of the bladder;

FIG. 10 is a perspective of four generally inflated bladders of the interior portion of the decorative covering in a generally assembled configuration;

FIG. 11 is a bottom plan of the bladders;

FIG. 12 is a side elevation of the bladders;

FIG. 13 is a top plan of the bladders;

FIG. 14 is a side elevation of the decorative covering installed to the lighting device with part of the decorative covering removed to illustrate the covering installed to the lighting device and with the illustrated bladders deflated;

FIG. 15 is the side elevation of FIG. 14 with the illustrated bladders inflated;

FIG. 16 is a perspective of a bladder of a decorative covering of another exemplary embodiment in which both ends of the bladder are generally flat;

FIG. 17 is a perspective of another exemplary embodiment illustrating a decorative covering having a generally spherical shape installed to a lighting device;

FIG. 18 is a top plan thereof;

FIG. 19 is a side elevation thereof;

FIG. 20 is a bottom plan of the decorative covering with the lighting device removed;

FIG. 21 is an exploded perspective of the decorative covering and lighting device;

FIG. 22 is the side elevation of FIG. 19 with part of the decorative covering removed to illustrate the covering installed to the lighting device;

FIG. 23 is a perspective of another exemplary embodiment illustrating a decorative covering having a generally spherical shape installed to a lighting device;

FIG. 24 is a side elevation thereof with part of the decorative covering cut away to illustrate the covering installed to the lighting device;

FIG. 25 is a side elevation of another exemplary embodiment illustrating a decorative covering having a generally spherical shape installed to a lighting device with part of the covering cut away to illustrate the covering installed to the lighting device;

FIG. 26 is a top perspective of another exemplary embodiment illustrating a decorative covering configured to resemble a snowman;

FIG. 27 is a bottom perspective thereof; and

FIG. 28 is a bottom plan thereof.

The drawings described herein are for illustration purposes only and are not intended to limit the scope of the present disclosure in any way.

### DETAILED DESCRIPTION

The following description is merely exemplary in nature and is in no way intended to limit the present disclosure, application, or uses. It should be understood that throughout the drawings, corresponding reference numerals indicate like or corresponding parts and features.

According to various aspects, exemplary embodiments are disclosed of inflatable decorative coverings that may be used for decorating a lighting device with a particular theme or motif. In one exemplary embodiment, an inflatable decorative covering is attachable to a lighting device for decorating the lighting device in accordance with a theme. In this particular embodiment, the inflatable decorative covering generally includes an exterior portion configured to resemble an object. The inflatable decorative covering also includes an interior portion disposed substantially within the exterior portion and defining a passage in the exterior portion. The interior portion being inflatable and having a first deflated configuration and a second inflated configuration. In the first deflated configuration, the decorative covering may be positioned to cover the lighting device with at least a portion of the lighting device within the passage. In the second inflated configuration, the exterior portion may be illuminated by light emitted from a light source of the lighting device thereby highlighting the object that the exterior portion resembles.

In another exemplary embodiment, an inflatable apparatus for decorating a lighting device generally comprises a decorative exterior portion and an interior portion disposed substantially within the exterior portion. The interior portion defines a channel configured for receiving at least a portion of the lighting device therein. The inflatable apparatus has a first deflated configuration in which the interior portion receives at least a portion of the lighting device within the channel. The inflatable apparatus also has a second inflated configuration in which the interior portion frictionally grips at least a portion of the lighting device within the channel to thereby retain the inflatable apparatus to the lighting device.

Another exemplary embodiment includes an inflatable decorative covering for decorating a lighting device. The lighting device includes a light source, a support to which the light source is mounted, and a solar panel for receiving sunlight for electrical power generation for operating the light source. In this particular embodiment, the inflatable decorative covering generally includes an exterior portion configured to resemble an object associated with a desired theme. At least one inflatable bladder is substantially surrounded by the exterior portion. The inflatable bladder defines a passage and has a first deflated configuration and a second inflated configuration. In the first deflated configuration, at least a portion of the support may be received within the passage. In the second inflated configuration, a portion of the bladder defining the passage frictionally grips at least a portion of the support within the passage. The inflatable decorative covering also includes a sunlight-transmissive portion configured to allow at least some sunlight to pass therethrough for receipt by the solar panel.

Another exemplary embodiment includes an apparatus for decorating an outdoor lighting device with a decorative exterior cover. The apparatus generally includes at least one inflatable bladder defining a passage and having a first deflated configuration and a second inflated configuration. In the first deflated configuration, at least a portion of the lighting device may be positioned within the passage. In the second inflated configuration, a portion of the bladder defining the passage frictionally grips at least a portion of the lighting device within the passage for retaining the bladder to the lighting device. The bladder defines an interior portion configured to allow the exterior decorative cover to be removably coupled thereto.

In still another exemplary embodiment, an inflatable apparatus configured to resemble an object related to a theme for decorating a lighting device generally comprises an inflatable portion configured for installation over the lighting device.

Various aspects disclosed herein relate generally to methods relating to kits including a plurality of interchangeable decorative coverings. The decorative coverings may include one ore more inflatable bladders and interchangeable coverings that may each be selectively used (e.g., slidably positioned over, wrapped around, etc.) with the inflatable bladders. In such embodiments, the interchangeable coverings may also be expandable or inflatable with fluid (e.g., liquid, gases, etc.), or the coverings may comprise a sufficiently flexible material that may be positioned over or wrapped around the inflatable bladders, or the coverings may be rigidly formed and fit over the inflatable bladders. Each of the interchangeable coverings within a kit need not necessarily be configured in the same way. That is, some coverings may be inflatable via fluid, while other coverings in the kit may not be. Plus, the coverings may each be associated with a different theme or motif (e.g., one for each of the twelve different months of the year, one for each of the major holidays, etc.). For example, one such kit may include a covering having an exterior configured to resemble a Halloween jack-o-lantern or ghost, a covering resembling a Christmas tree, a covering resembling a heart for Saint Valentine's day, a covering resembling a shamrock for Saint Patrick's day, a covering resembling an Easter egg, etc. Notably, these are only examples of possible themes and motifs, as the inflatable decorative coverings disclosed herein are not limited to any particular themes or motifs. Other possible examples include birthday-related themes (e.g., coverings configured to resemble a cake, candles, paper hats, etc.), sports-related themes (e.g., coverings configured to resemble sports-ball or equipment such as a football, soccer ball, baseball, baseball glove, baseball bat, golf ball, football helmet, etc.).

Additional aspects of the present disclosure relate to methods of using and/or making inflatable decorative coverings for lighting devices. One exemplary embodiment includes a method of decorating a lighting device. In this embodiment, the method generally includes positioning a deflated covering on the lighting device, and then inflating the covering. At least a portion of the covering may frictionally engage (e.g., grip, compressively squeeze, etc.) at least a portion of the lighting device to removably attach the covering to the lighting device. In another embodiment, the covering may include a fastener for removably attaching the covering to the lighting device or other support structure (e.g., the ground).

Still further aspects relate to methods of decorating an outdoor walkway having a plurality of existing light sources along the walkway for lighting the walkway. In such embodiments, a method may include decorating the various lighting devices with inflatable decorative coverings of the present disclosure consistent with a common theme or motif. For example, a first lighting device may be provided with an inflatable decorative covering configured to resemble a locomotive, a second lighting device may be provided with an inflatable decorative covering configured to resemble a caboose, and the remaining intermediate or middle lighting devices may be provided with coverings configured to resemble other train cars, such as coal cars or freight cars. In this exemplary manner, the walkway is thus provided with a train-type theme or motif.

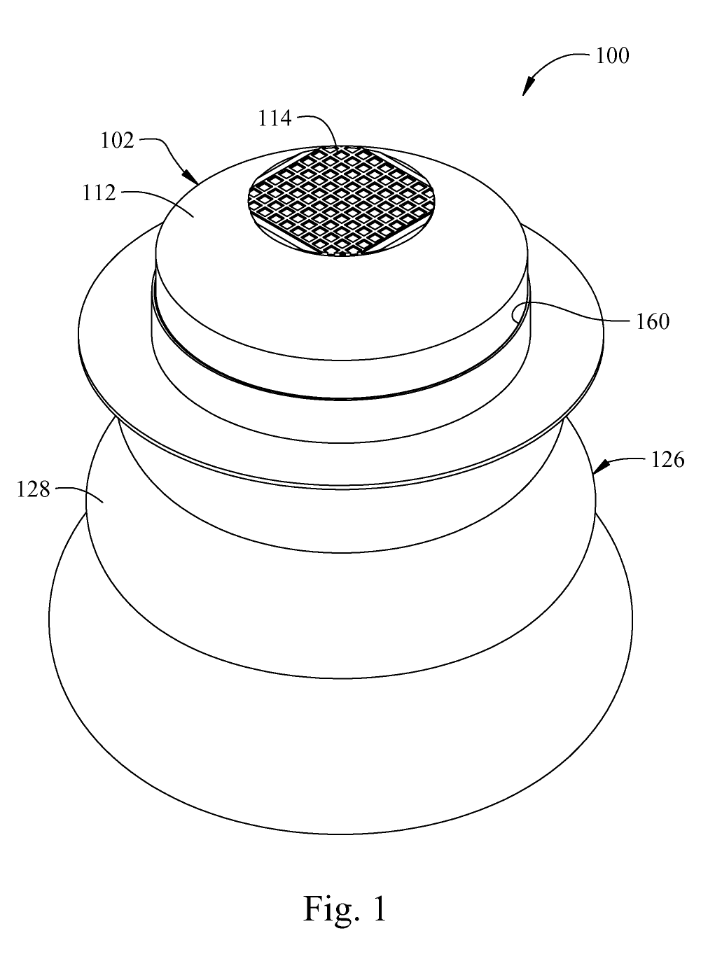

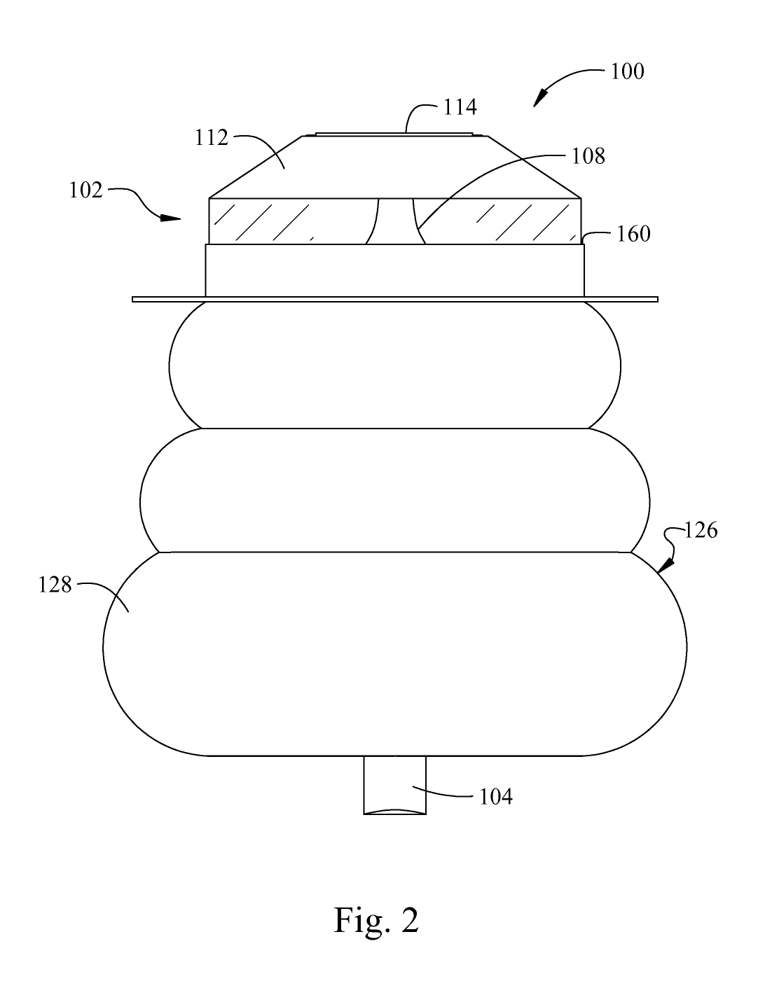

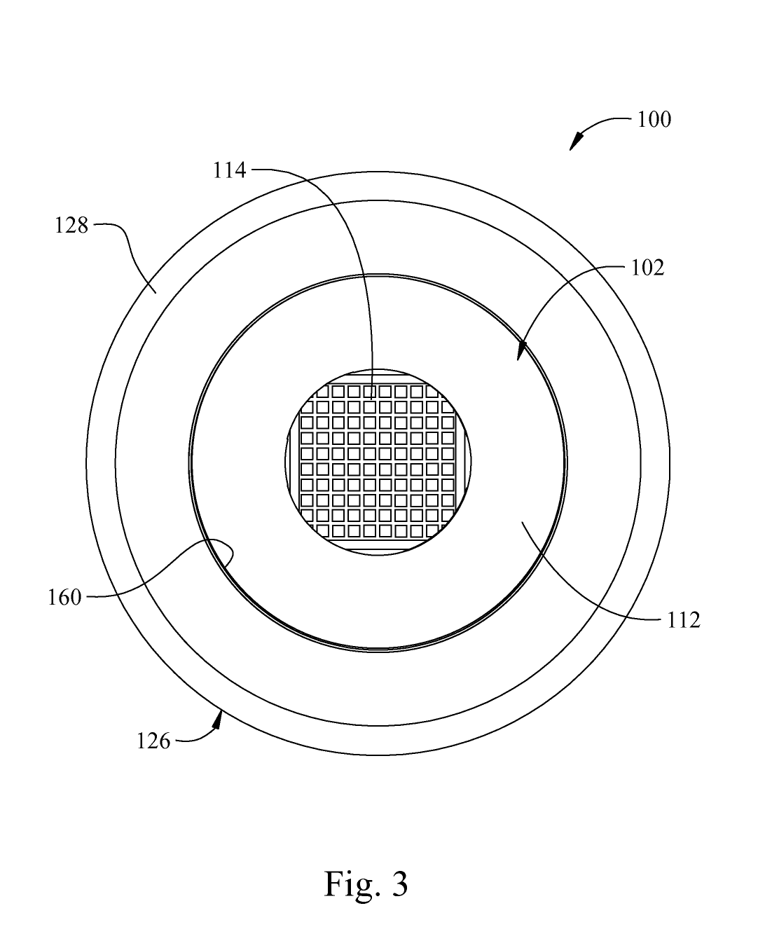

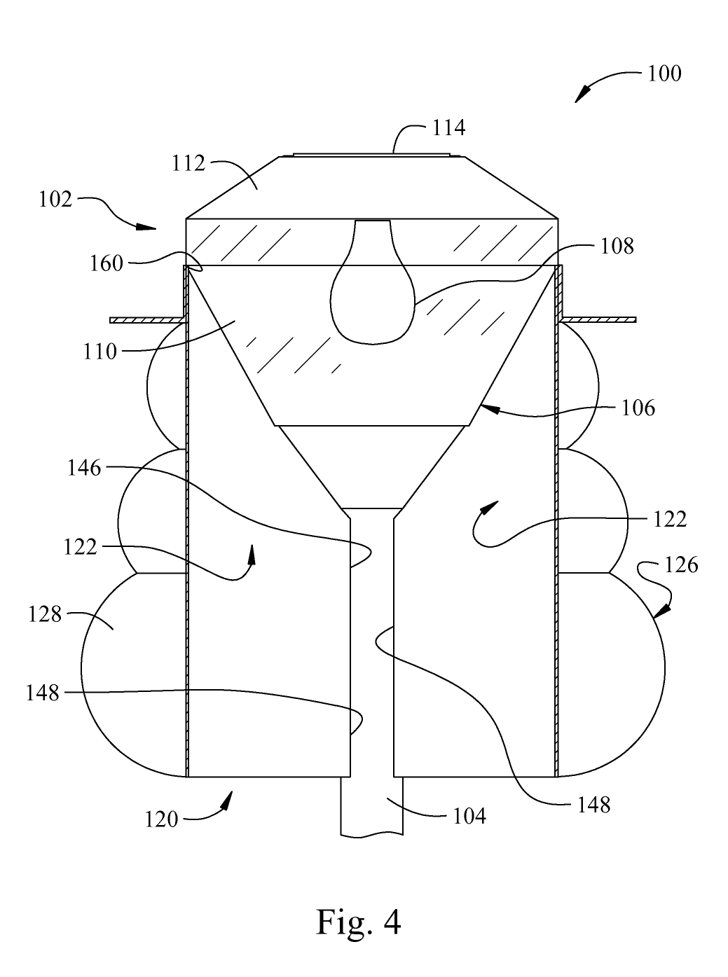

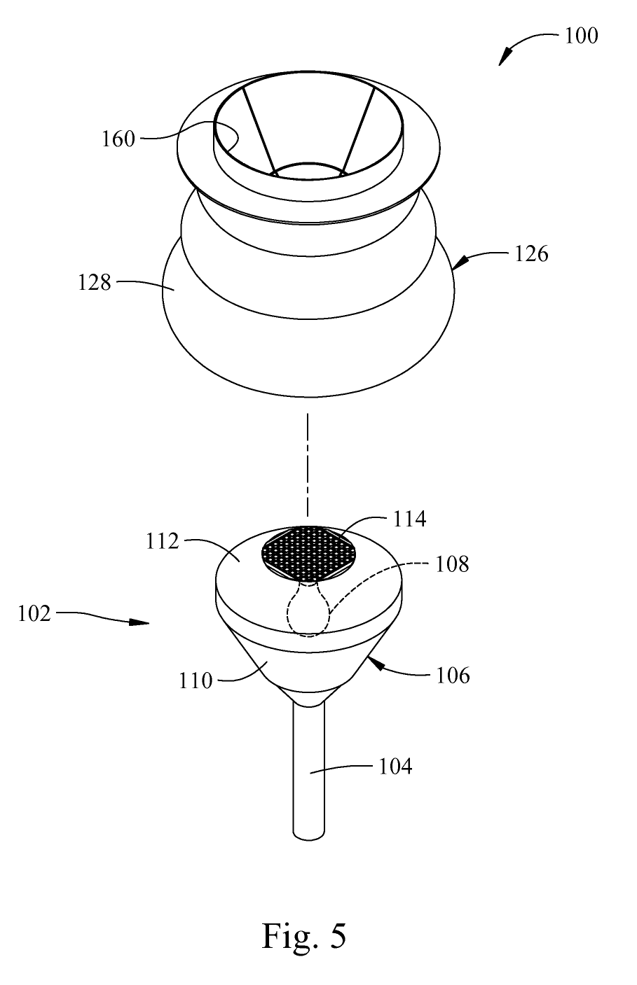

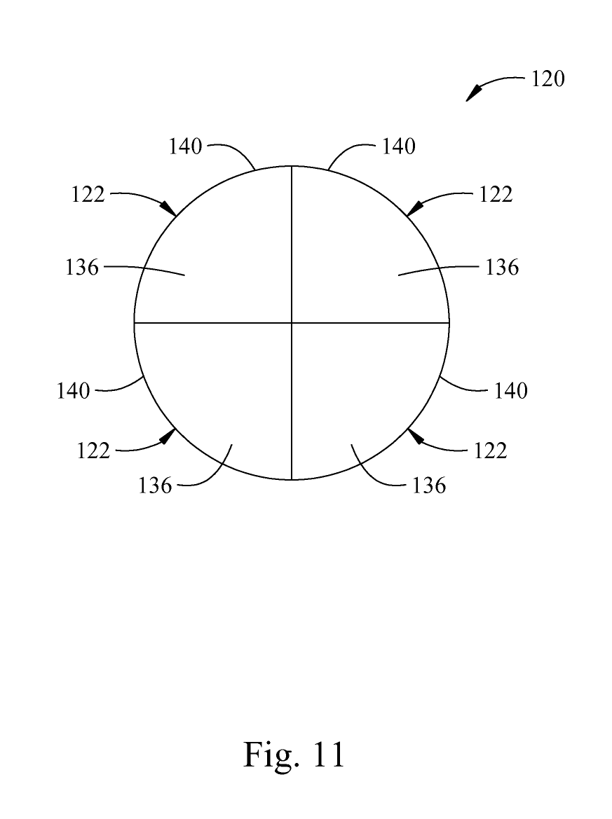

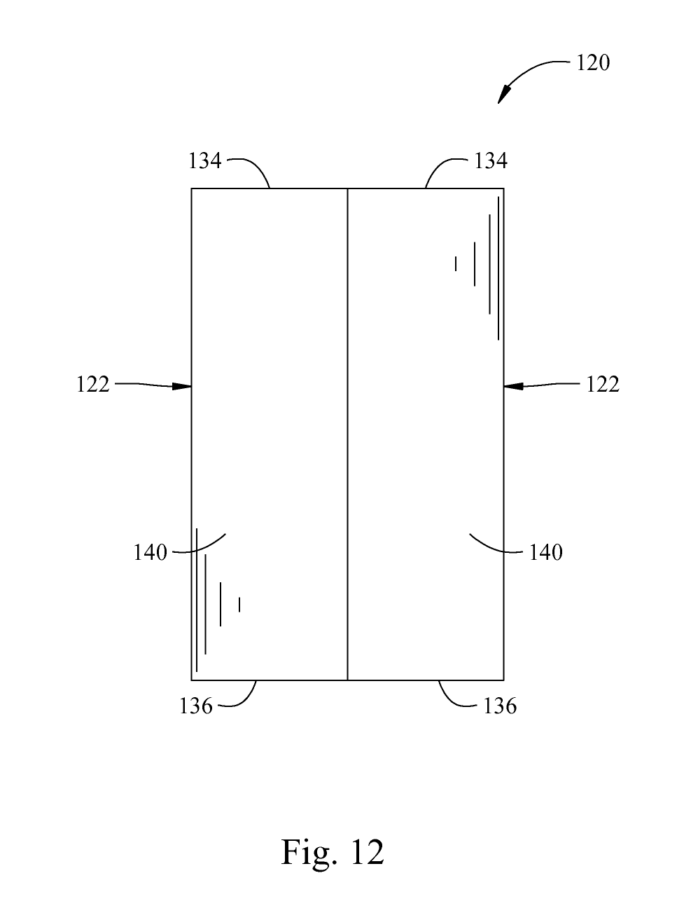

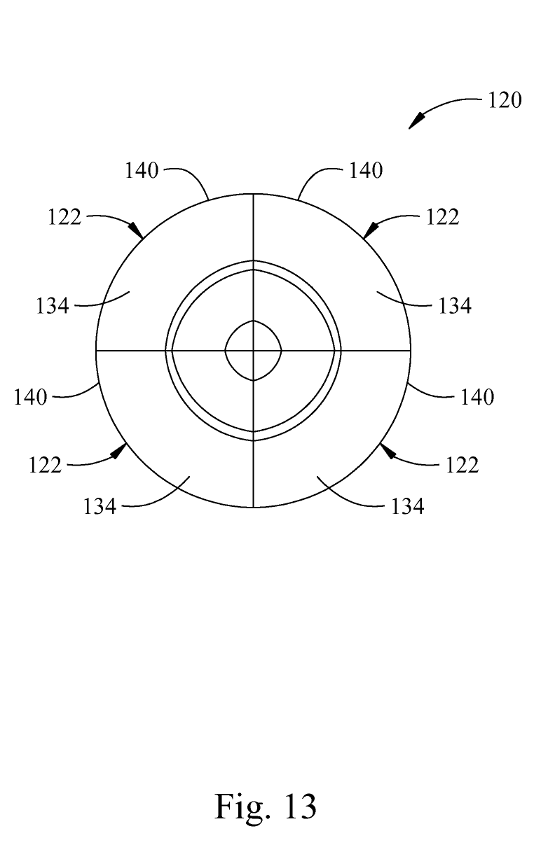

Referring now to the drawings, FIGS. 1 through 15 show an exemplary embodiment of an inflatable decorative covering 100 capable of being removably attached (broadly, removably coupled) to a lighting device 102. The decorative covering 100 can be used for decorating the lighting device 102 in accordance with a desired theme. As can be seen in the drawings, the illustrated decorative covering 100 incorporates a snowman design in accordance with a winter theme. In other exemplary embodiments, a decorative covering may incorporate, for example, a jack-o'-lantern design, an Easter egg design, a train design, a baseball design, or any other suitable design, form, shape, etc., in accordance with a desired theme.

With reference to FIGS. 1 through 5, the outdoor lighting device 102 to which the decorative covering 100 is attached comprises an upwardly extending post 104 (broadly, a support) and a light fixture 106 mounted on the post. A light source 108 is contained within the light fixture 106 and may comprise one or more of light bulbs, light emitting diodes (LEDs), or other suitable light sources, including low heat emitting light sources, etc. The light fixture 106 is generally frusto-conical in shape and includes a transparent or translucent shield 110 for allowing light from the light source 108 to pass through, and a lid 112 over the shield 110 covering the light source 108. A solar panel 114 is located generally on top of the lid 112 and in electrical connection with the light source 108 for receiving sunlight and generating electrical power to operate the light source. In other exemplary embodiments, an indoor lighting device or a combination indoor/outdoor lighting device may be used. In still other exemplary embodiments, a lighting device may include a fixture having a shape different from the fixture 106 illustrated herein, or the lighting device may include a fixture without a shield. In some exemplary embodiments, a lighting device may not include a fixture at all such that a light source is mounted directly on a post or other support with electrical power supplied thereto. For example, the lighting device may comprise a string of light sources with a decorative covering attached to one or more of light sources along the string. In still other exemplary embodiments, a solar panel may be located on directly on a post of a lighting device, or may be located separate from the lighting device and connected thereto. In still other exemplary embodiments, electrical power may be provided to a lighting device and light source by low voltage AC, batteries, hydrogen, wind, or other electrical power sources.

The decorative covering 100 is inflatable and generally includes an interior portion 120 and a decorative exterior portion 126. In the illustrated embodiment, the interior portion 120 is inflatable and comprises four inflatable bladders 122 (or chambers), and the exterior portion 126 is defined by an exterior cover 128 substantially receiving the bladders therein. The inflatable bladders 122 (broadly, expandable fluid containers or expandable fluid compartments) generally define the interior portion 120. In other exemplary embodiments, an interior portion of a decorative covering may comprise more than or fewer than four inflatable bladders. For example, the interior portion may comprise a single inflatable bladder. Furthermore, the inflatable bladder of the interior portion may be integral with an exterior portion of the covering. In still other exemplary embodiments, an exterior portion of a decorative covering may only receive part of an interior portion such that at least part of the interior portion extends out of the exterior portion. In some embodiments, an interior portion of a decorative covering may also comprise a sleeve configured to fit over a lighting device. In these embodiments, for example, inflatable bladders may be configured to attach to the sleeve for removably attaching the decorative covering to the lighting device. The sleeve may comprise a piece of plastic, rubber, etc. that is inserted between the bladders to hold the cover to the lighting device. The exterior portion 126 in the illustrated embodiment is configured to resemble a snowman. In other exemplary embodiments, however, an exterior portion may be configured to resemble a jack-o'-lantern, an Easter egg, a train, a baseball, or any other suitable design, form, shape, etc., in accordance with the desired theme.

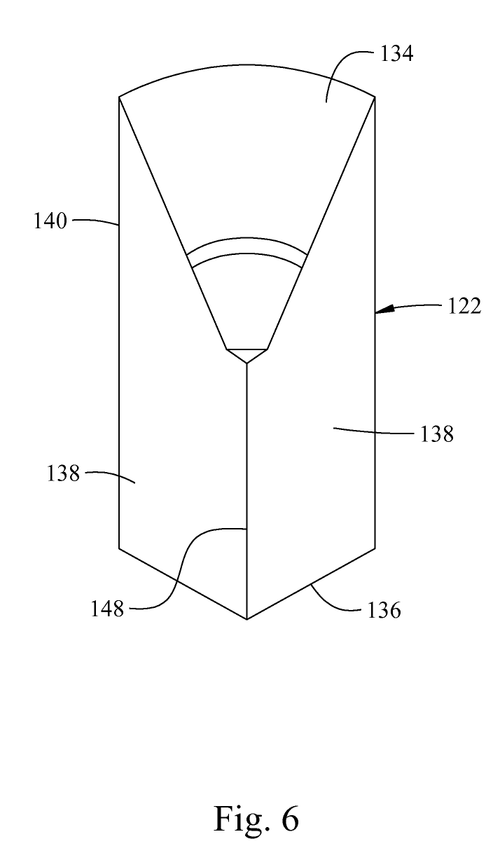

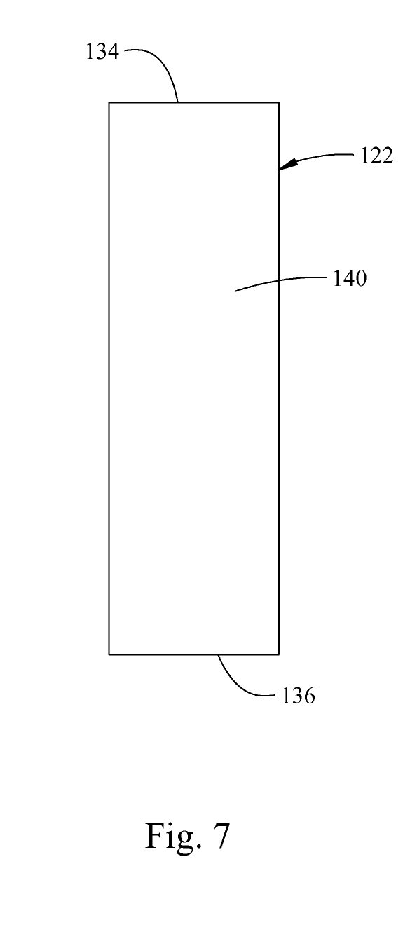

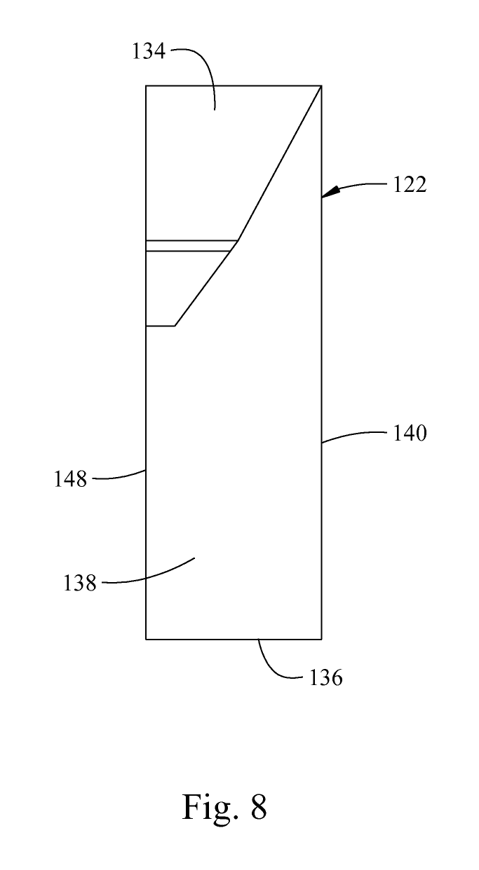

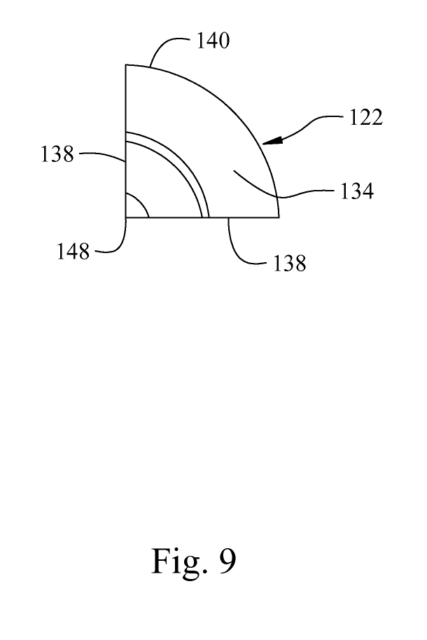

In FIGS. 6 through 9, an individual one of the bladders 122 of the interior portion 120 is shown schematically in a generally inflated configuration apart from the exterior portion 126 of the decorative covering 100. It should be understood that the other bladders 122 are similarly shaped, and a description of the other bladders is substantially the same as the description of the illustrated bladder 122. The illustrated bladder 122 is generally elongate and generally rectangular in shape when viewed from the side (FIGS. 7 and 8) and generally wedge-shaped when viewed from below (or above, FIG. 9). One end 134 (e.g., an upper end) is generally frusto-conical in shape while the opposite end 136 (e.g., a lower end) is generally flat. Side surfaces 138 are substantially flat, while an outer surface 140 is generally rounded. In other exemplary embodiments, one or more bladder may be shaped differently than illustrated herein, and one or more bladder may be shaped differently from other bladders of an interior portion.

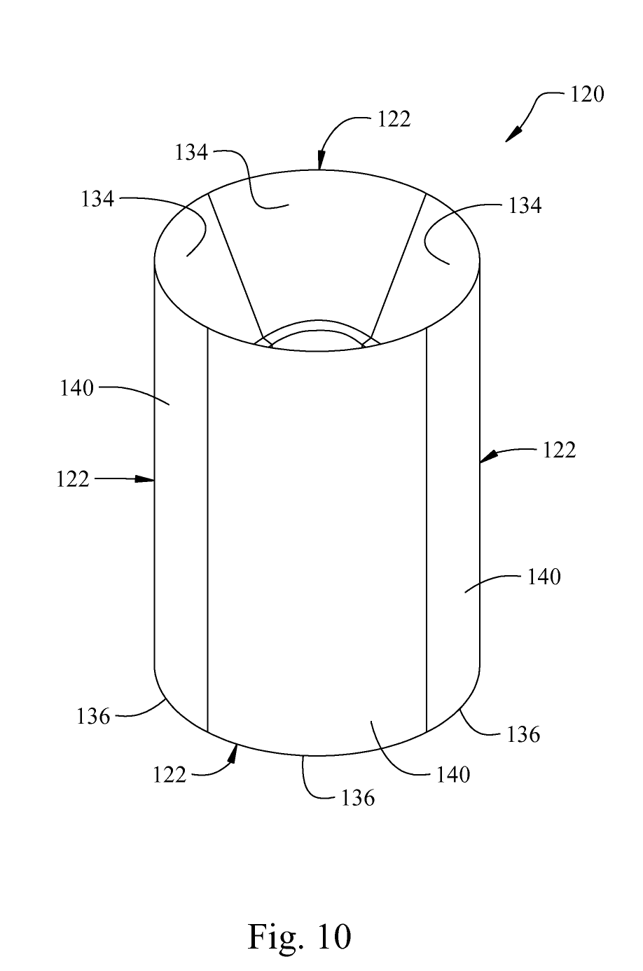

FIGS. 10 through 13 schematically illustrate the four bladders 122 of the interior portion 120 in an assembled configuration, and again generally inflated and apart from the exterior portion 126. The assembled bladders 122 are arranged in a generally cylindrical orientation, with each bladder occupying about one quarter of the orientation. The side surfaces 138 of adjacent bladders 122 engage, and the rounded outer surfaces 140 coincide to form the generally cylindrical orientation. In the illustrated embodiment, the bladders 122 are not connected or attached (they instead only abut at the side surfaces). In other exemplary embodiments, however, bladders of an interior portion may be integrally connected to one or more of the other bladders. For example, engaging side surfaces of two adjacent bladders may be interconnected by suitable connecting means, for example, hot melt, glue, stitches, seams, buttons, clasps, Velcro® or other hook and loop fasteners, magnets, buckles, double sided tape, zippers, detents, ribs, etc. In still other exemplary embodiments, a single bladder may define an interior portion of a decorative covering such that the single bladder is inflatable.

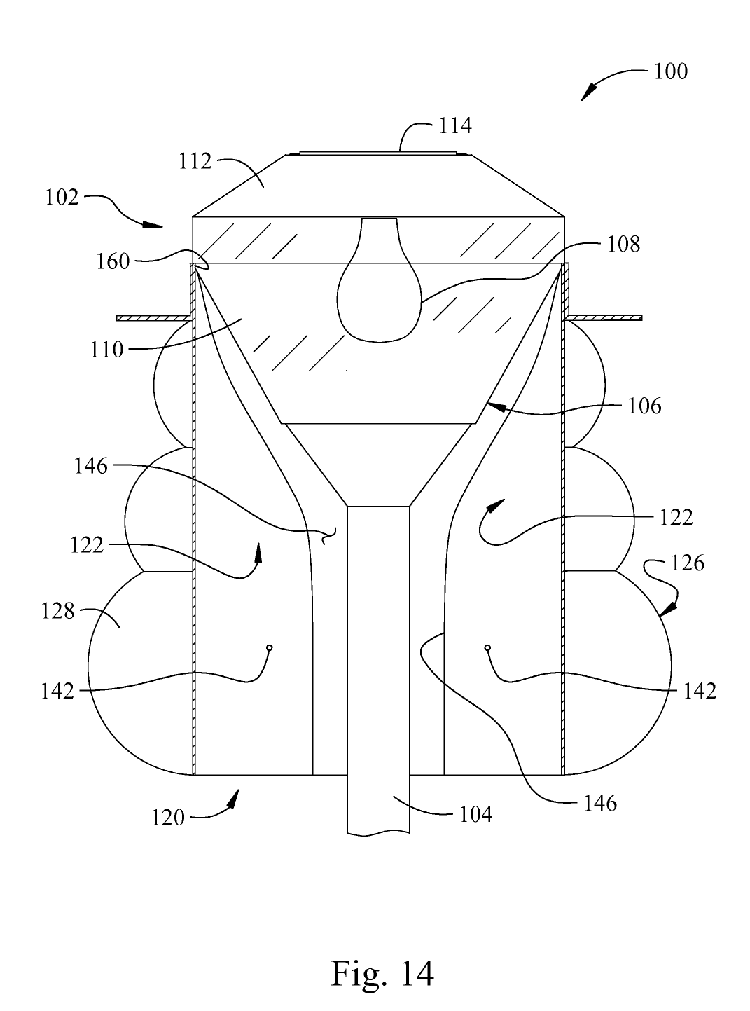

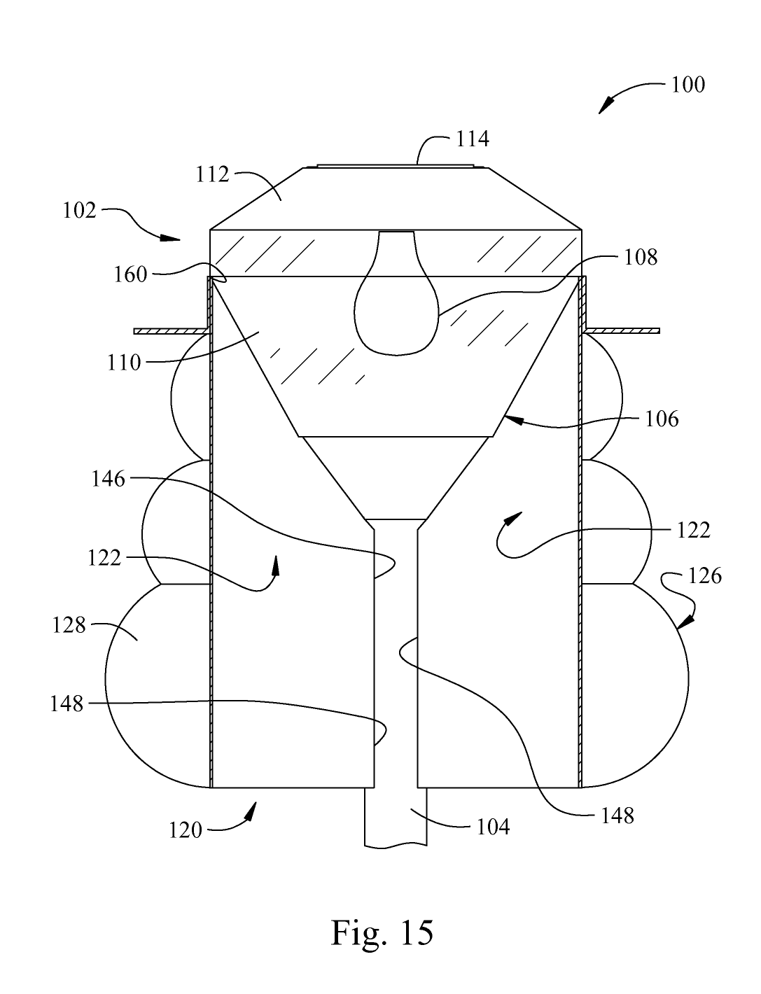

Referring now to FIGS. 14 and 15, the interior portion 120 and exterior portion 126 of the decorative covering 100 are illustrated together with the lighting device 102. Part of the exterior portion 126 is cut away and one of the bladders 122 of the interior portion 120 is removed for ease of illustration. As can be seen, the bladders 122 are received substantially within the exterior portion 126. The exterior portion 126 is connected or attached to each of the bladders 122 so that the exterior portion may be removably attached to the lighting device 102 with the bladders. The exterior portion 126 may be connected or attached to each of the bladders 122 by suitable attaching means, for example, hot melt, glue, stitches, seams, buttons, clasps, Velcro® or other hook and loop fasteners, magnets, buckles, double sided tape, zippers, detents, ribs, frames, flaps, string, rope, etc. In some exemplary embodiments, an exterior portion of a decorative covering may be removably attached to an interior portion. For example, the exterior portion may be removably attached to one or more bladders of an interior portion so that the bladders can be removed from the exterior cover. In other exemplary embodiments, an exterior portion of a decorative covering may be integrally formed with an interior potion. For example, the exterior portion may be at least partly defined by an outer surface of one or more bladders of the interior portion.

The illustrated decorative covering 100 is removably attached to the lighting device 102 by first installing the covering to the lighting device (FIG. 14) and then inflating (broadly, expanding) (FIG. 15) the bladders 122 of the interior portion 120. As shown in FIG. 14, the decorative covering 100 is installed to the lighting device 102 when the bladders 122 are in a first, deflated configuration. This allows the decorative covering 100 to be, for example, slid over the lighting device 102. The deflated bladders 122 and exterior portion 126 surrounding the bladders are both generally open at a lower end of the decorative covering 100 and facilitate, for example, sliding the covering over the lighting device 102. The deflated bladders 122 are generally collapsed and substantially limp and may relatively easily receive the lighting device 102 substantially between the bladders through a passage 146 (or channel) cooperatively defined by the bladders 122 of the interior portion 120, generally through a center of the assembled bladders (and thus, generally a center of the interior portion). The limp bladders 122 may be manipulated to adjust the shape of the passage 146 as necessary to more easily and accurately position the lighting device 102 therein. In the illustrated embodiment, the passage 146 receives part of the post 104 and shield 110 of the lighting device 102. Part of the post 104 extends outward through the lower end of the decorative covering 100, and part of the shield 110 extends outward through an upper end of the decorative covering 100. In other exemplary embodiments, an interior portion of a decorative covering may receive substantially all of a lighting device so that no part of the lighting device extends outward of the covering. In these embodiments, the decorative covering substantially encloses the lighting device.

In other exemplary embodiments, a decorative covering may be, for example, removably attached to a lighting device by wrapping the covering around the lighting device. Here, the decorative covering may include a seam defined by generally opposite first and second end portions of the covering engageable to each other and configured to allow the decorative covering to be wrapped generally around the lighting device and be thusly retained, or secured thereto by the subsequent engagement of the first and second end portions at the seam. Engagement of the first and second end portions may be accomplished by any suitable devices, including snaps, buttons, clasps, Velcro® or other hook and loop closures, magnets, buckles, double sided tape, zippers, detents, ribs, etc. In some of these exemplary embodiments, the seam may be a single seam formed integrally with and defined by coinciding first and second end portions of an interior portion and exterior portion of the decorative covering. In other of these embodiments, an interior portion and an exterior portion of the decorative covering may each include a seam so that opposite first and second end portions of the interior portion are engageable to each other at a seam, and opposite first and second end portions of the exterior portion are enlargeable to each other at a seam. It should be understood that in describing a decorative covering as removably attached, or removably coupled, or installed, or secured, the inventor intends to include, for example, wrapping the decorative covering around a lighting device and/or sliding the decorative covering over a top (or bottom) of a lighting device and/or other acceptable means, etc.

With reference still to FIGS. 14 and 15, once the decorative covering 100 is installed to the lighting device 102, the bladders 122 can be inflated to an inflated configuration (FIG. 15) for retaining the decorative covering 100 on the lighting device 102. Inflating the bladders 122 may be accomplished by introducing suitable fluid into the bladders, including liquids (e.g., water, etc.), gases (e.g., helium, air, oxygen, etc.), or combinations thereof, from a suitable source of fluid (e.g., an air compressor, etc.). In the illustrated embodiment, each bladder 122 includes an inlet 142 (broadly, an inflation opening) (FIG. 14) for receiving the fluid. A plug or other suitable structure may be provided for each of the inlets 142 to block or close the inlets once each of the bladders 122 receives a desired amount of fluid. In other exemplary embodiments, an interior portion (e.g., a bladder, etc.) may include an inlet comprising a valve assembly or other sealing/controlling member for controlling fluid flow into the interior portion and preventing undesired fluid release out of the interior portion. In still other exemplary embodiments, a decorative covering may comprise an interior portion having at least one inlet continuously connected to a fluid source for providing sufficient and continuous fluid flow through the inlet into the interior portion to inhibit deflation of the interior portion. In yet other exemplary embodiments, a decorative covering may comprise an interior portion having multiple bladders. Here, one or more fluid channels may be provided between some or all of the bladders for fluidly connecting the bladders and collectively inflating the bladders via a common source of fluid. Alternatively, a single inlet may be provided for inflating all of the fluidly connected bladders. Valve systems may be provided in the fluid channels between the bladders for controlling fluid flow between the bladders. In further exemplary embodiments, a decorative covering may comprise an interior portion that may be deflated, or collapsed, from an inflated configuration to a deflated configuration when desired by releasing fluid from the interior portion, for example, through one or more inlets of the interior portion. For example, a plug of may be removed from a desired inlet to allow the fluid to flow out of the interior portion. In still further exemplary embodiments, a decorative covering may comprise an interior portion with one ore more outlets separate form one ore more inlets for releasing fluid from the interior portion.

Once the bladders 122 are inflated (FIG. 15), the passage 146 closes around the lighting device 102 (the post 104 and fixture 106 in the illustrated embodiment) and substantially conforms to the outer profile of the portion of the lighting device 102 therein (the post 104 and fixture 106). The post 104 of the lighting device 102 is generally engaged by vertices 148 of the bladders 122, and the fixture 106 is generally engaged by the aligned frusto-conical ends 134 of the bladders 122. This engagement of the bladders 122 with the lighting device 102 squeezes (i.e., frictionally grips) the lighting device and thusly helping to securely retain the decorative covering 100 thereon and helping to retain the positioning of the decorative covering relative to the lighting device 102. It can be seen in FIG. 15 that in the illustrated embodiment the passage 146 substantially corresponds to the shape of the lighting device 102 within the passage. In the illustrated embodiment, the passage 146 of the inflated bladders 122 defines a generally circular shape as the vertices 148 of the bladders 122 grip the circular post 104 and as the frusto-conical portions grip the frusto-conical fixture 106 of the lighting device 102. In other exemplary embodiments, a decorative covering may comprise an interior portion having a passage that defines other shapes substantially different from the shape of a lighting device received in the passage and still frictionally grip the lighting device for retaining the decorative covering on the lighting device.

As previously stated, the exterior portion 126 is configured to resemble a predetermined object or character related to the desired theme associated with the decorative inflatable covering 100. For example in the illustrated embodiment, the exterior portion 126 is configured to resemble a snowman. To provide the desired shape, form, configuration, etc. to the exterior portion 126 to resemble the predetermined object or character (e.g., the snowman, etc.), the exterior portion 126 may be configured to receive fluid (e.g., liquids, gases, or combinations thereof, etc.) from a fluid source (e.g., an air compressor, etc.) for inflating the exterior portion 126 to the desired configuration independent from inflation of the bladders 122 of the interior portion 120. Thus, the inflated exterior portion 126 may have a shape different from that of the inflated bladders 122. Inflation of the exterior portion 126 may be achieved using similar structures and devices to those described regarding inflation of the bladders 122. For example in some exemplary embodiments, a decorative covering comprises an exterior portion having an inlet (broadly, an inflation opening) for receiving fluid to inflate the exterior portion. A plug may be provided to block or close the inlet once the exterior portion receives a desired amount of fluid. In some of these embodiments, the inlet may include a valve assembly or other sealing/controlling member for controlling fluid flow into the exterior portion of the decorative covering and for preventing undesired fluid release out of the exterior portion. In other of these embodiments, a fluid source may be continuously connected to the inlet of the exterior portion for providing sufficient fluid flow through the inlet into the exterior portion to inhibit deflation thereof. In still other of these embodiments, one or more fluid channels may be provided between the exterior portion and an inflatable interior portion of the decorative covering for fluidly connecting the exterior portion and the interior portion and for collectively inflating the exterior portion and the interior portion via a common source of fluid. In yet other of these embodiments, fluid may be introduced into both the exterior portion and interior portion via the inlet in the exterior portion or may be introduced via one ore more inlets in the interior portion. Valve systems may be provided between the exterior portion and interior portion for controlling fluid flow therebetween. In further of these embodiments, the exterior portion may be deflated, or collapsed, when desired by releasing fluid from the exterior portion through the inlet. Alternatively, an outlet may be provided form releasing fluid separate from the inlet receiving fluid. Further yet, the exterior portion and interior portion may be deflated simultaneously by releasing fluid from a common inlet or outlet. In still other exemplary embodiments, a decorative covering may comprise an inflatable interior portion having a shape substantially similar to that of an inflatable exterior portion.

In other exemplary embodiments, a decorative covering may comprise an inflatable interior portion and a non-inflatable exterior portion configured to resemble a predetermined object or character. For example, the exterior portion may be formed rigidly as the predetermined object or character (e.g., by a mold process, other shaping process, etc.). The rigid cover may then be attached or connected (fixedly or removably) to the interior portion for installation to a lighting device. Alternatively, the interior portion may be integral with the rigid cover so that the rigid cover forms an outer surface of the interior portion and the interior portion inflates inward of the cover. Also for example, the exterior portion may be substantially flexible for taking the resemblance of the predetermined object or character. Here in one embodiment, a support structure (e.g., an internal frame, etc.) may be used to conform the exterior portion to the shape of the predetermined object or character. Here in another embodiment, inflation of the interior portion may be used to conform the exterior portion to the shape of the predetermined object or character.

With reference now to FIGS. 1 through 5, 14, and 15, the exterior portion 126 of the decorative covering 100 includes a sunlight-transmissive portion 160 defined generally by an opening in a hat of the snowman of the exterior portion. When the decorative covering 100 is installed to the lighting device 102, the sunlight-transmissive portion 160 substantially conforms to the shape of the lid 112 of the lighting device 102 and allows at least some sunlight to pass therethrough for receipt by the solar panel 114 for providing electrical power to the light source 108 to illuminate the light source. When the light source 108 is lit, the exterior portion 126 is illuminated by light emitted by the light source through the bladders 122 of the interior portion 120 thereby highlighting the predetermined object that the exterior portion 126 resembles. In the illustrated embodiment, the sunlight transmissive portion 160 comprises an opening for allowing sunlight to pass therethrough. In other exemplary embodiments, a decorative covering may comprise an exterior portion having a sunlight-transmissive portion formed from a substantially transparent or translucent material covering a solar panel of a lighting device for allowing at least some sunlight to pass through the sunlight-transmissive portion to the solar panel.

The interior portion 120 of the decorative covering 100, and thus the bladders 122 thereof, are substantially transparent or translucent for allowing a substantial amount of light from the light source 108 to pass therethrough to the exterior portion 126. To accomplish this, the interior portion 120/bladders 122 may be formed from any suitable material configured for receiving and transmitting light from the light source 108. For example in some exemplary embodiments, a decorative covering may comprise an interior portion formed from one or more of polyvinyl chloride (PVC), paper, nylon, and a heat-resistant material configured for withstanding heat generated by operation of a light source. In other exemplary embodiments, a decorative covering may comprise an interior portion formed from less heat-resistant materials or cost-saving materials for use with a light source comprising, for example, one or more of an LED or other low heat-generating light source etc.

As previously stated, the exterior portion 126 of the decorative covering 100 is configured for receiving and altering light from the light source 108 by at least one or more of refracting, reflecting, diffracting, dispersing, and diffusing such that the altered light illuminates the exterior portion 126 thereby highlighting the predetermined object or character that the exterior portion resembles. To accomplish this, the exterior portion 126 may be formed from any suitable material configured for receiving and altering light from the light source 108 by at least one or more of refracting, reflecting, diffracting, dispersing, and diffusing. For example in some exemplary embodiments, a decorative covering may comprise an exterior portion formed from one ore more of polyvinyl chloride (PVC), paper, nylon, and a heat-resistant material configured for withstanding heat generated by operation of the light source 108. In other exemplary embodiments, a decorative covering may comprise an exterior portion formed from less heat-resistant materials or cost-saving materials for use with a light source comprising, for example, one or more of an LED or other low heat-generating light source, etc.

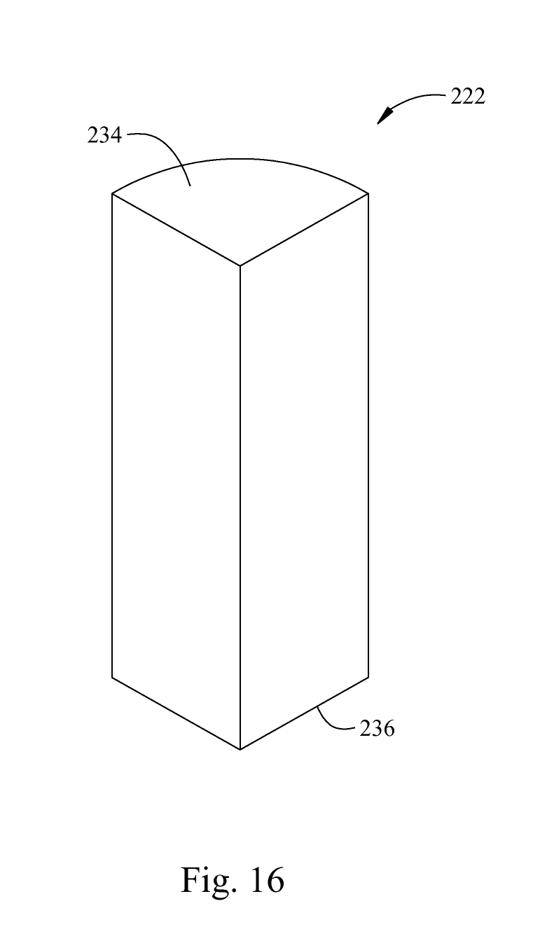

FIG. 16 illustrates a bladder 222 of a decorative covering of another exemplary embodiment. Here, upper and lower ends 234 and 236 of the bladder 222 are similarly shaped and are both generally flat. In all other regards, the bladder 222 is substantially the same as the bladders 122 of the decorative covering 100 previously described and illustrated in FIGS. 1 through 15.

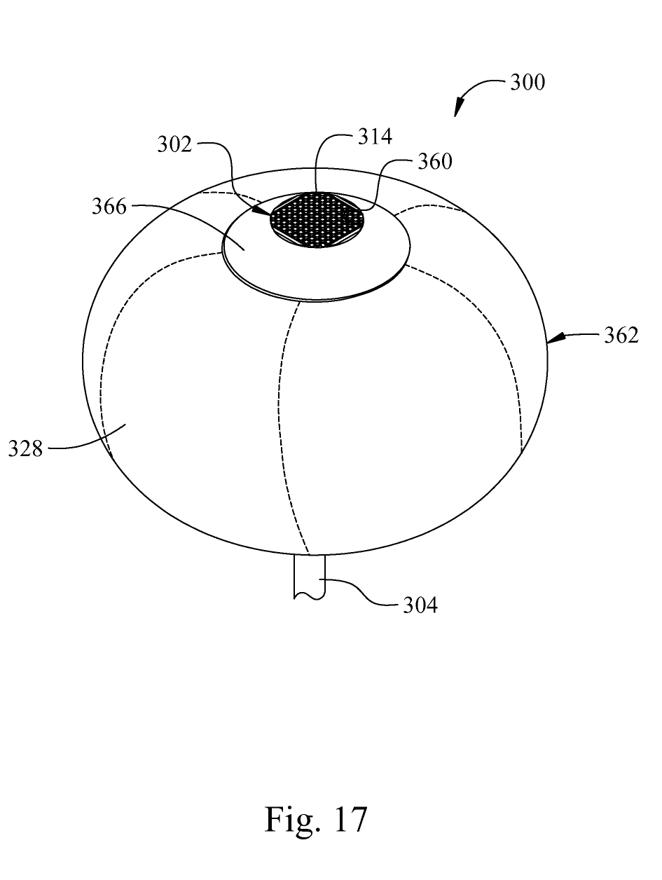

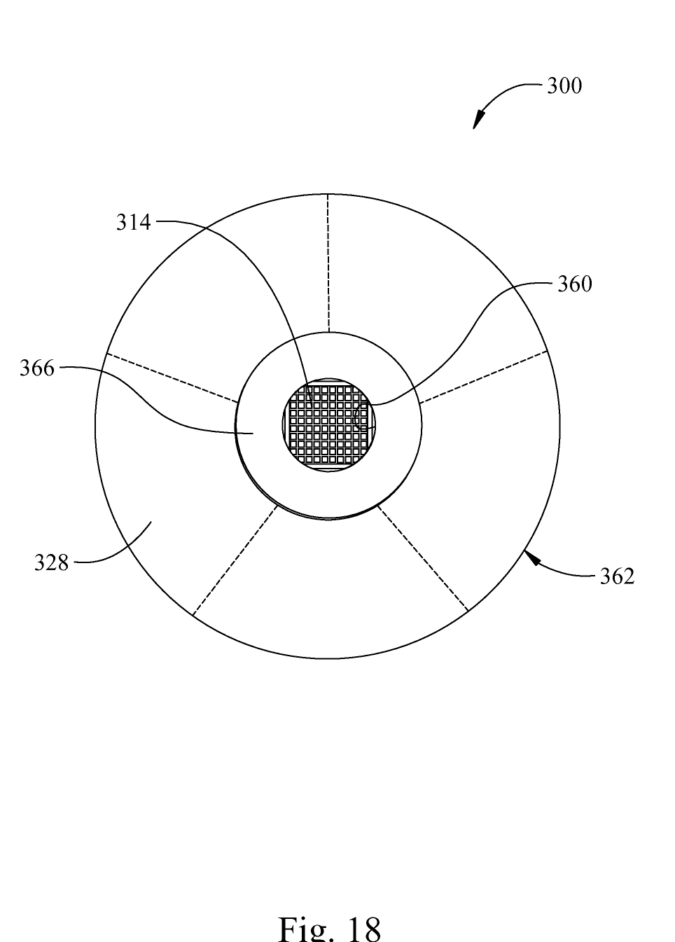

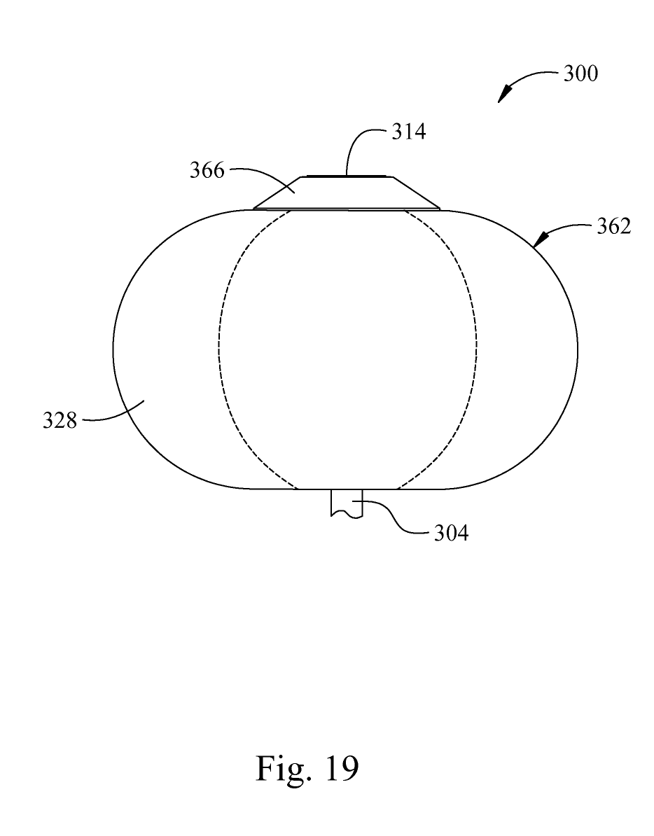

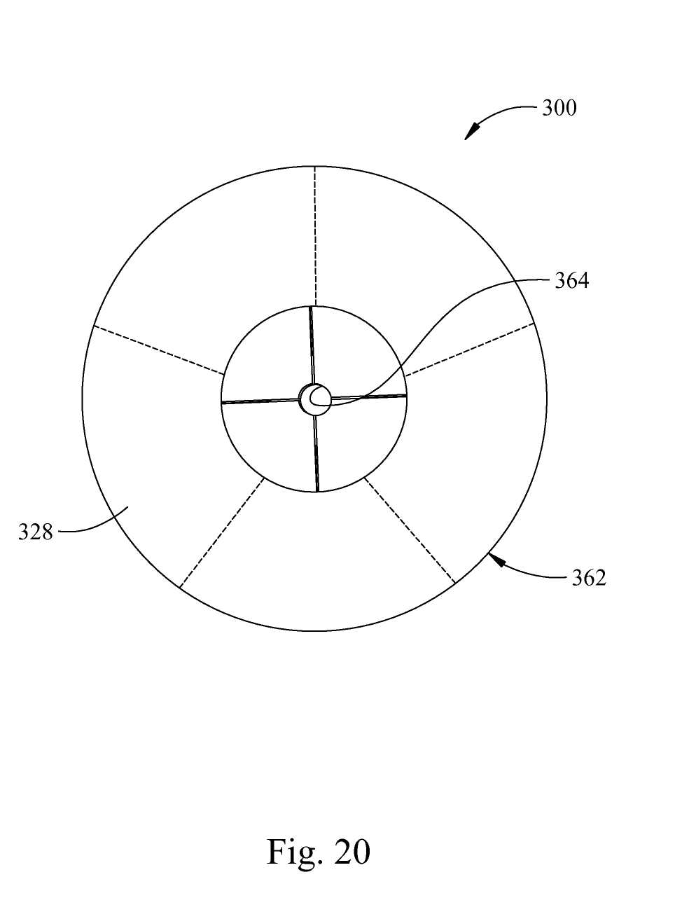

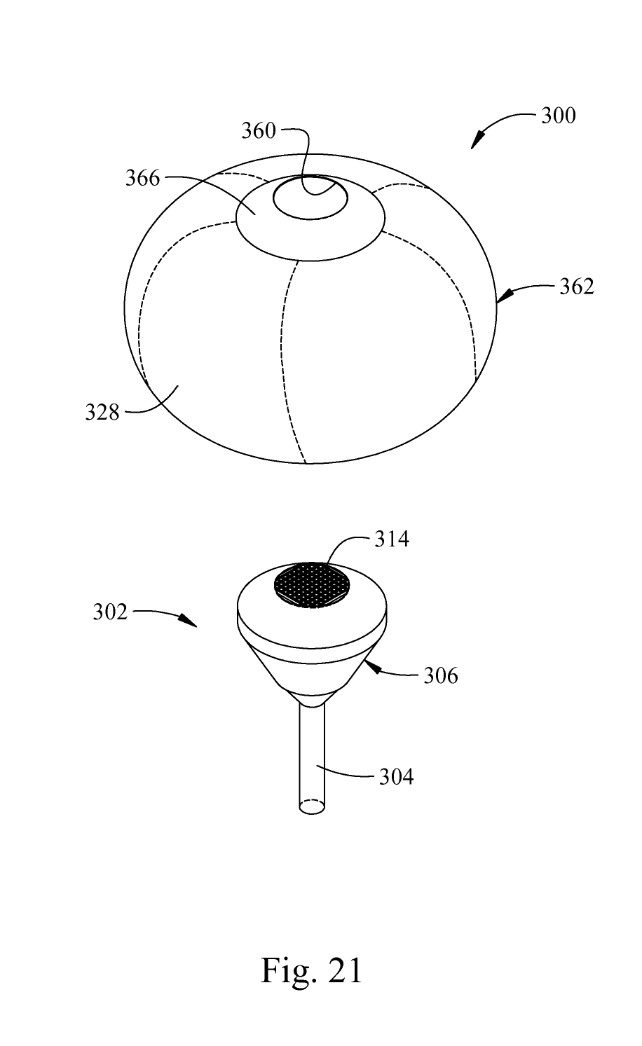

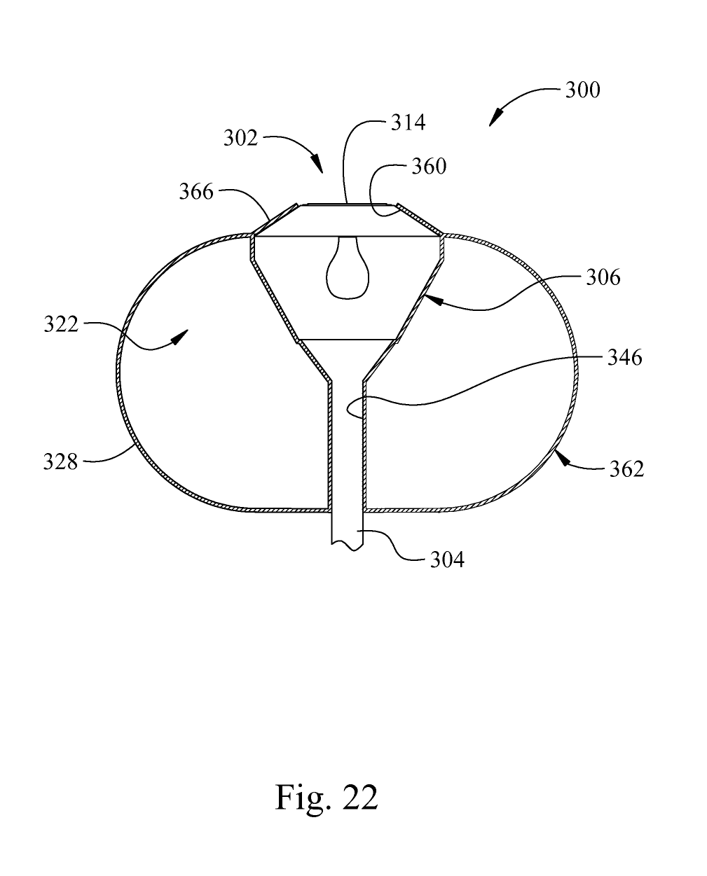

FIGS. 17 through 22 illustrate another exemplary embodiment of a decorative covering 300 capable of being removably attached to a lighting device 302. The decorative covering 300 is configured to resemble a generally spherical shape. The covering 300 is shown in an inflated configuration in the drawings, and comprises a portion 362 having an interior chamber (or portion) 322 (FIG. 22) configured to receive a fluid (e.g., a liquid, a gas, or a combinations thereof, etc.) for inflation and an exterior cover (or portion) 328 extending substantially around (and configured to cover) the interior chamber so that the interior chamber is disposed substantially within the exterior cover. In this embodiment, the interior chamber 322 and exterior cover 328 are integrally formed such that an outer surface of the interior chamber substantially corresponds to and defines the exterior cover 328. Thus, when the decorative covering 300 is installed to the lighting device 302 and the interior chamber 322 is inflated, the interior chamber 322 takes on a generally spherical shape forming the generally spherical shape of the exterior cover 328 and decorative covering 300.

The illustrated decorative covering 300 is installed to the lighting device 302 when the interior chamber 322 is deflated. This allows the decorative covering 300 to be, for example, slid over the lighting device 302. The deflated interior chamber 322 and exterior cover 328 surrounding the chamber are both generally open at 364 at a lower end of the decorative covering 300 to facilitate, for example, sliding the covering 300 over the lighting device 302. The deflated interior chamber 322 is generally collapsed and substantially limp and may relatively easily receive the lighting device 302 into the decorative covering 300 through a central passage 346 defined by the interior chamber 322. The limp interior chamber 322 may be manipulated to adjust the shape of the passage 346 as necessary to more easily and accurately position the lighting device 302 therein. As shown in FIG. 22, the passage 346 receives part of a post 304 and part of a fixture 306 of the lighting device 302. Part of the post 304 extends outward of the decorative covering 300 through the opening 364, and part of the fixture 306 is received in a sunlight-transmissive portion 360 of the decorative covering 300. An upper sleeve 366 of the decorative covering 300 rests on a solar panel 314 in a lid 312 of the fixture 306. The sunlight-transmissive portion 360 is illustrated as an opening in the decorative covering 300 configured to allow at least some sunlight to pass therethrough for receipt by the solar panel 314 for providing electrical power to the lighting device 302.

Once the decorative covering 300 is installed to the lighting device 302, the interior chamber 322 can be inflated for retaining the decorative covering 300 on the lighting device 302. The passage 346 closes around the lighting device 302 (the post 304 and the fixture 306) and substantially conforms to the outer profile of the portion of the lighting device 302 therein (the post 304 and the fixture 306). The post 304 and fixture 306 are engaged by the interior chamber 322, which squeezes (i.e., frictionally grips) the post and fixture thusly helping to securely retain the decorative covering 300 on the lighting device 302 and helping to retain the positioning of the decorative covering relative to the lighting device 302.

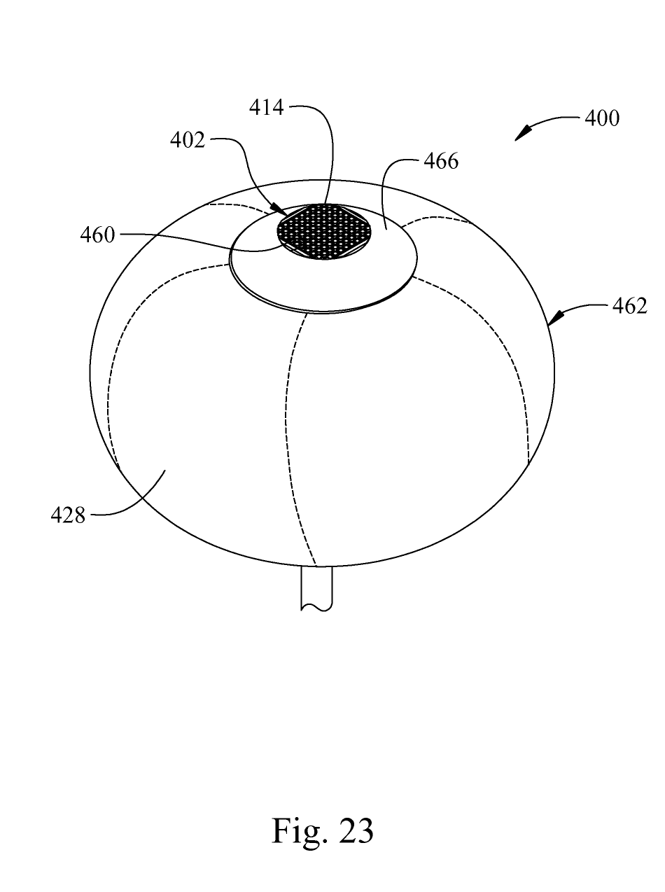

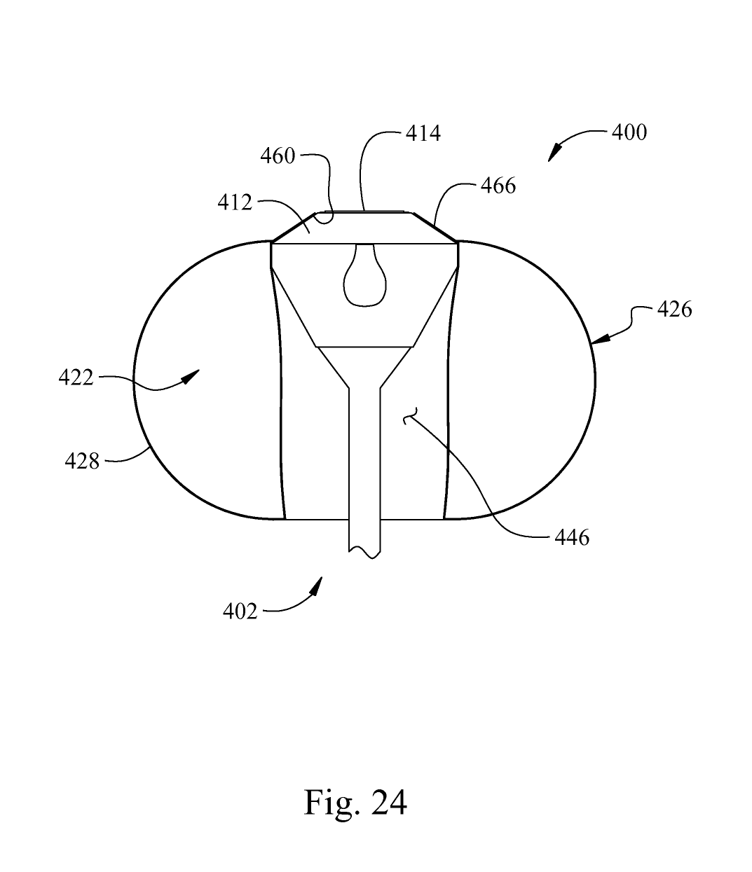

FIGS. 23 and 24 illustrate another exemplary embodiment of a decorative covering 400 capable of being removably attached to a lighting device 402. The decorative covering 400 is similar to the decorative covering 300 previously described and illustrated in FIGS. 17 through 22. The decorative covering 400 comprises a portion 462 having an interior chamber (or portion) 422 (FIG. 24) configured to receive a fluid (e.g., a liquid, a gas, or a combinations thereof, etc.) for inflation and an exterior cover (or portion) 428 extending substantially around (and configured to cover) the interior chamber so that the interior chamber is disposed substantially within the exterior cover. The interior chamber 422 and exterior cover 428 are integrally formed such that an outer surface of the interior chamber substantially corresponds to and defines the exterior cover 428. Thus, when the decorative covering 400 is installed to the lighting device 402 and the interior chamber 422 is inflated, the interior chamber 422 takes on a generally spherical shape forming the generally spherical shape of the exterior cover 428 and decorative covering 400.

The illustrated decorative covering 400 may be installed to the lighting device 402 when the interior chamber 422 is deflated or inflated. In this embodiment, the decorative covering 400 is not frictionally secured to the lighting device 402; the interior chamber 422 does not frictionally grip the lighting device 402 within passage 446. Instead in this embodiment, the decorative covering 400 slides over the lighting device 402 and an upper sleeve 466 adjacent a sunlight-transmissive portion 460 of the covering 400 rests on a solar panel 414 in a lid 412 of the lighting device 402, thus retaining the covering 400 to the lighting device 402. In other exemplary embodiments, a decorative covering may be retained to a lighting device by other components of the covering resting on components of the lighting device. For example, a post of the lighting device may include a pedestal or other structure for supporting the decorative covering. In still other exemplary embodiments, a decorative covering may be installed to a lighting device by wrapping the decorative covering around the lighting device. In yet other exemplary embodiments, a decorative covering may include counter weights for securely holding the covering on a lighting device.

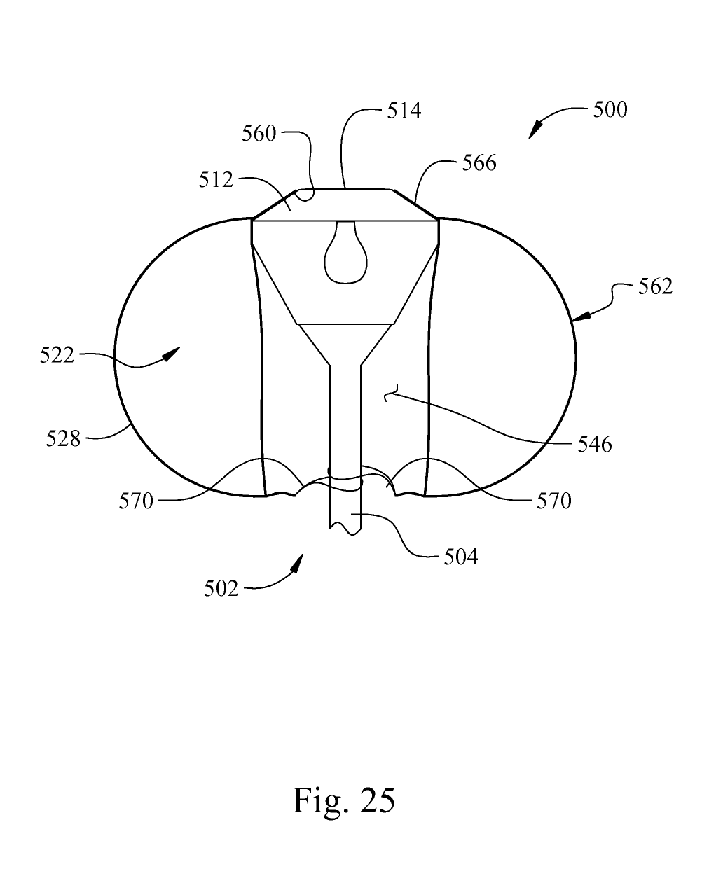

FIG. 25 illustrates another exemplary embodiment of a decorative covering 500 capable of being removably attached to a lighting device 502. The decorative covering 500 is substantially similar to the covering 400 previously described and illustrated in FIGS. 23 and 24. The decorative covering 500 comprises a portion 562 having an interior chamber 522 configured to receive a fluid (e.g., a liquid, a gas, or a combinations thereof, etc.) and an exterior cover 528 extending substantially around (and configured to cover) the interior chamber. The interior chamber 522 and exterior cover 528 are integrally formed such that an outer surface of the interior chamber substantially corresponds to and defines the exterior cover 528. Thus, when the decorative covering 500 is installed to the lighting device 502 and the interior chamber 522 is inflated, the interior chamber 522 takes on a generally spherical shape forming the generally spherical shape of the exterior cover 528 and decorative covering 500.

The illustrated decorative covering 500 may be installed to the lighting device 502 when the interior chamber 522 is deflated or inflated. In this embodiment, the decorative covering 500 is not frictionally secured to the lighting device 502; the interior chamber 522 does not frictionally grip the lighting device 502 within passage 546. Instead in this embodiment, the decorative covering 500 slides over the lighting device 502 and an upper sleeve 566 adjacent a sunlight-transmissive portion 560 of the covering 500 rests on a solar panel 514 in a lid 512 of the lighting device 502. Also in this embodiment, one ore more fasteners (e.g., ropes, string, Velcro® or other hook and loop fasteners, buckles, screws, nails, etc.) may be used to help removably attach the decorative covering 500 to the lighting device 502 after it is installed. For example in the illustrated embodiment, two tie-type fasteners 570 attached or connected to the decorative covering 500 are tied to a post 504 of the lighting device 502 (e.g., around the post, or to a detent on the post, etc.) to help removably attach the decorative covering 500 to the lighting device 502. In other exemplary embodiments, a decorative covering may include one or more fasteners attached or connected to the decorative covering differently (e.g., at different locations) than illustrated herein.

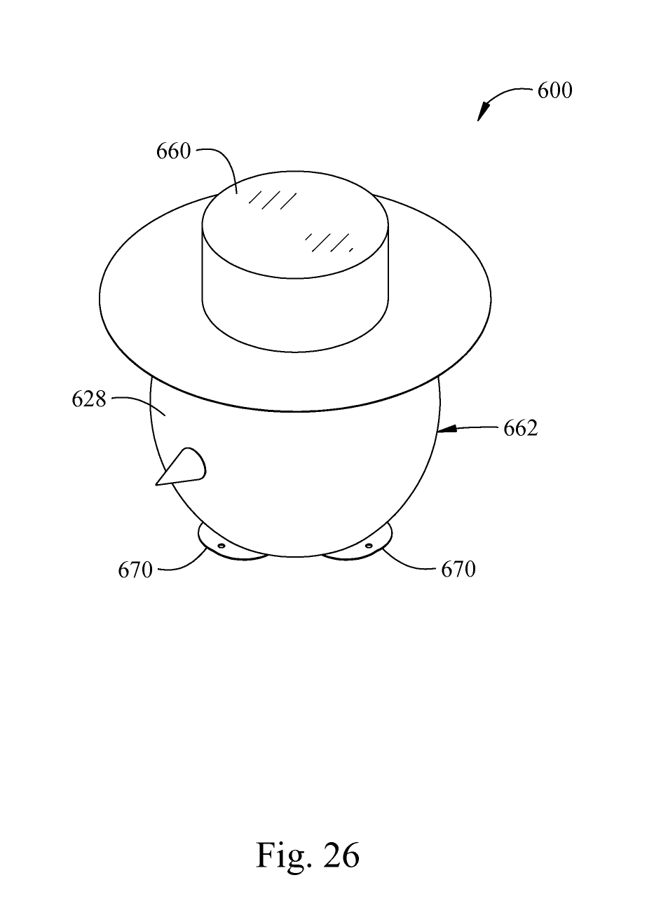

FIGS. 26 through 28 illustrate another exemplary embodiment of a decorative covering 600 capable of being removably attached to a lighting device (not shown). The decorative covering 600 is substantially similar to the decorative coverings 400 and 500 previously described and illustrated in FIGS. 23 and 24 and FIG. 25, respectively. The decorative covering 600 comprises a portion 662 having an interior chamber (not visible) configured to receive a fluid (e.g., a liquid, a gas, or a combinations thereof, etc.) and an exterior cover 628 extending substantially around (and configured to cover) the interior chamber. The interior chamber and exterior cover 628 are integrally formed such that an outer surface of the interior chamber substantially corresponds to and defines the exterior cover 628. Thus, when the decorative covering 600 is installed to the lighting device and the interior chamber is inflated, the interior chamber takes on a generally spherical shape forming the general snowman shape of the decorative covering 600.

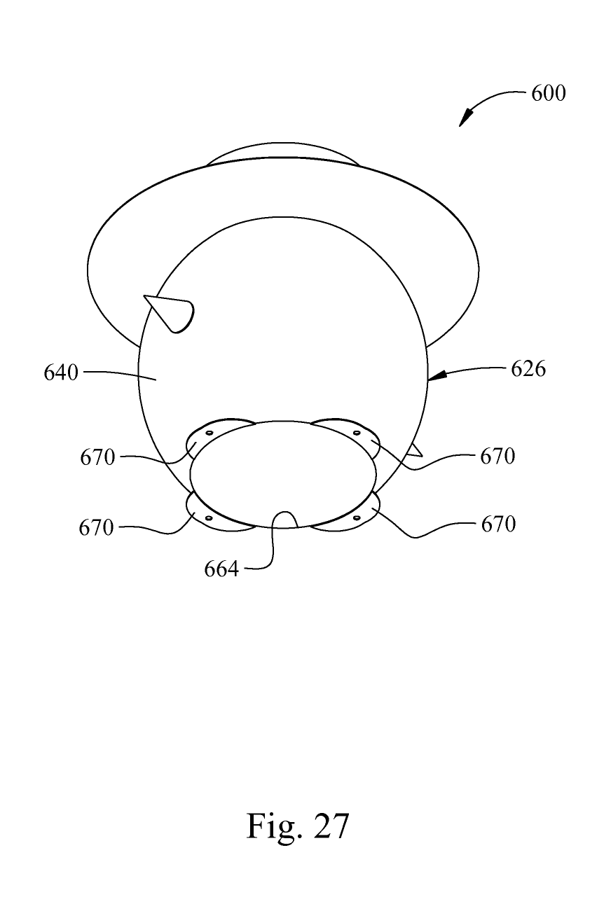

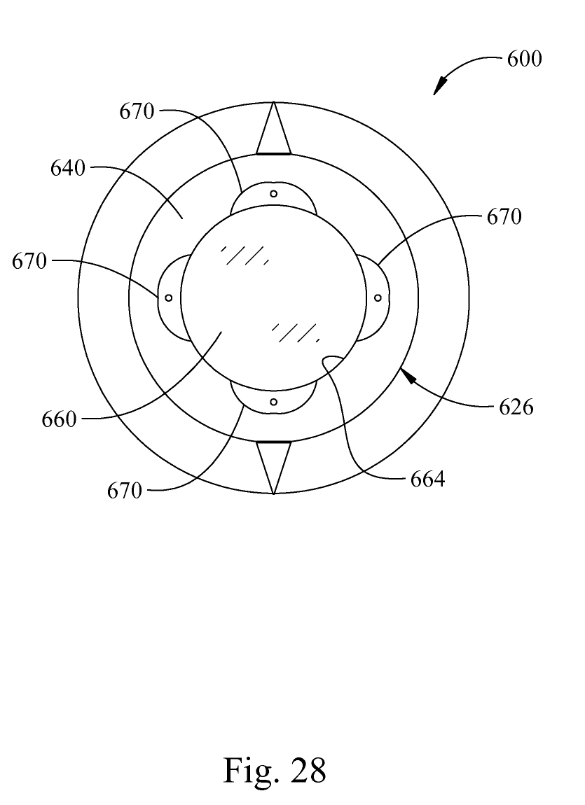

Similar to the illustrated decorative covering 500 (FIG. 25), the illustrated decorative covering 600 may be installed to the lighting device when the interior chamber is deflated or inflated. The decorative covering 600 is not frictionally secured to the lighting device, and the interior chamber does not significantly frictionally grip the lighting device to attach it thereto. Instead in this embodiment, the decorative covering 600 slides over the lighting device so that a sunlight-transmissive portion 660 of the covering 600 generally rests on a solar panel (not shown) in a lid of the lighting device. The sunlight-transmissive portion 660 is formed from a substantially transparent or translucent material for allowing at least some sunlight to pass through the sunlight-transmissive portion 660 to the solar panel. A lower part of the decorative covering 600 adjacent opening 664 (FIGS. 27 and 28) is configured to generally rest on a secondary surface or structure (e.g., ground, concrete, wood, building structure, lighting device structure, etc.) after being installed to the lighting device for support/stabilization.

As can be seen in the figures, four fasteners 670 are provided for use to help removably attach/support/stabilize the decorative covering 600 after it is installed to the lighting device. The fasteners 670 are each located toward a lower part of the decorative covering 600 adjacent the opening 664, and are attached or connected to the exterior cover 628. In this embodiment, the fasteners 670 are configured to attach or connect the decorative covering 600 to the secondary surface or structure upon which the covering generally rests. The fasteners 670 are each illustrated as a flap of material (e.g., fabric, etc.) with an opening therein for receiving a stake, nail, etc. into the secondary surface or structure so that the decorative covering 600 will not be blown off by excessive winds or taken off by animals or other environmental forces, etc. In other exemplary embodiments, a decorative covering may include fasteners formed as one piece with the covering or fasteners configured differently than illustrated herein. In still other exemplary embodiments, a decorative covering with fasteners may be secured to a secondary surface or structure by other suitable means (e.g., staples, nails, screws, string, etc. through flaps comprising different material, or directly through a part of the decorative covering (e.g., an exterior cover or an interior chamber, etc.)). In yet other exemplary embodiments, a decorative covering may include one or more fasteners attached or connected to an interior chamber of the covering.

In still other exemplary embodiments, an inflatable decorative covering may include a light source internal to the covering and pluggable to a power source (e.g., a low voltage AC source, batteries, a hydrogen source, a wind source, a solar source or other electrical power source, etc.). For example, an LED may be attached or connected internal to the decorative covering. In these embodiments, the decorative covering need not be secured to an external light source. Instead, the decorative covering can be positioned at a desired location regardless of whether a light source is in the location because the internal light source can be activated to light the covering.

In yet other embodiments, one or more decorative coverings may be installed to one or more LEDs or regular light bulbs of a string of lights. The one or more decorative coverings may then be attached or connected to the LEDs or light bulbs, directly to the light string, or to other secondary surfaces or structures as disclosed herein. For example, a string of lights may be positioned along the ground, and decorative coverings may be installed to each light bulb of the string of lights and attached or connected to the ground through fasteners of the coverings.

As previously stated, it is envisioned that in some exemplary embodiments in which a decorative covering includes an exterior portion distinct from an interior portion (e.g., not integrally formed, etc.) that the exterior portion may be removably coupled to the interior portion. In some of these embodiments, the interior portion may be installed to a lighting device and inflated, and then the exterior portion may be subsequently attached to the interior portion. In still other exemplary embodiments, a decorative covering may include different, interchangeable exterior portions capable of use with an interior portion. For example, a kit may include the inflatable interior portion and a plurality of interchangeable decorative exterior portions each configured to be removably coupled to the interior portion, whereby a user can choose which interchangeable decorative exterior portion and theme associated therewith is to be provided to a lighting device by selectively coupling a corresponding one of the interchangeable decorative exterior portions to the interior portion.

In other exemplary embodiments, a decorative covering may be configured to be removably coupled to a lighting device so that a light source of the lighting device is positioned generally toward a lower end, or portion, of the covering. For example, during installation to the lighting device the decorative covering may slide upward over the lighting device which, for example, may be a street light in which an arm extends away from the street light and angles generally downward toward the ground/street. Here, when sliding the decorative covering over the street light arm, the light source extends generally downward through a passage formed by an interior portion of the decorative covering. In this manner, the light source is positioned generally toward a lower end of the passage, and is thus positioned generally toward a lower portion of the decorative covering.

Accordingly, various embodiments provide inflatable decorative coverings (e.g., 100, 200, 300, 400, 500, 600, etc.) that may be used in conjunction with a wide range of lighting device, such as solar-powered outdoor lighting systems, indoor lighting devices, battery-powered lighting devices, lighting devices that include LEDs, lighting devices powered by low voltage alternative current (AC), wind-powered light sources, hydrogen-powered light sources, light sources powered by other means, low-heat generating light sources, etc. Accordingly, the specific references to outdoor lighting devices should not be construed as limiting the scope of the present disclosure.

It should also be noted that embodiments and aspects of the present disclosure may be used in a wide range of applications, including with indoor or outdoor lighting devices and fixtures that do not include light sources. Accordingly, the scope of the present disclosure should not be limited to use with any one specific form/type of fixture.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. An inflatable decorative covering for attachment to a lighting device for decorating the lighting device in accordance with a theme, the inflatable decorative covering comprising:
an exterior portion configured to resemble an object;
an interior portion disposed substantially within the exterior portion and defining a passage in the exterior portion, the interior portion being inflatable and having a first deflated configuration in which the decorative covering may be positioned to cover the lighting device with at least a portion of the lighting device within the passage, and a second inflated configuration;
whereby when the interior portion is in the inflated configuration, the exterior portion may be illuminated by light emitted from a light source of the lighting device thereby highlighting the object that the exterior portion resembles.

2. The inflatable decorative covering of claim 1, wherein the interior portion frictionally grips at least a portion of the lighting device when in the inflated configuration for attaching the inflatable decorative covering to the lighting device.

3. The inflatable decorative covering of claim 2, wherein the interior portion comprises at least one inflatable bladder configured to be inflated for defining said passage with a shape in conformance with at least a portion of the lighting device for frictional gripping engagement therewith.

4. The inflatable decorative covering of claim 1, wherein the lighting device comprises an upwardly extending post, and wherein the interior portion comprises a plurality of inflatable bladders configured to be inflated for cooperatively defining said passage with at least a portion having a shape in conformance with the upwardly extending post for frictional gripping engagement therewith.

5. The inflatable decorative covering of claim 1, further comprising a sunlight-transmissive portion configured to allow at least some sunlight to pass through for receipt by a solar panel associated with the lighting device for electrical power generation for operation of the light source.

6. The inflatable decorative covering of claim 5, wherein the sunlight-transmissive portion comprises an opening through the inflatable decorative covering.

7. The inflatable decorative covering of claim 5, wherein the sunlight-transmissive portion comprises substantially transparent or translucent material.

8. The inflatable decorative covering of claim 1, wherein the exterior portion is configured to resemble a character or figurine.

9. The inflatable decorative covering of claim 1, wherein the decorative covering comprises at least one or more of polyvinyl chloride (PVC), paper, nylon, and a heat-resistant material configured for withstanding heat generated by operation of the light source.

10. The inflatable decorative covering of claim 1, wherein the interior portion is at least substantially transparent for allowing a substantial amount of light from the light source to pass therethrough to the exterior portion, and wherein the exterior portion is configured for receiving and altering light from the light source by at least one or more of refracting, reflecting, diffracting, dispersing, and diffusing such that the altered light illuminates the exterior portion thereby highlighting the object that the exterior portion resembles.

11. The inflatable decorative covering of claim 10, wherein the exterior portion is configured to alter light from the light source such that the altered light is color-coordinated with the object.

12. The inflatable decorative covering of claim 1, further comprising a seam defined by generally opposite first and second end portions engageable to each other and configured to allow the decorative covering to be wrapped generally around the lighting device and be retained thereto by the subsequent engagement of the first and second end portions at the seam.

13. The inflatable decorative covering of claim 1, further comprising an internal frame for supporting at least a portion of the exterior portion after inflation of the interior portion.

14. The inflatable decorative covering of claim 1, wherein the exterior portion is inflatable separate from the interior portion.

15. The inflatable decorative covering of claim 1, further comprising a closable inflation opening for providing a fluid into the decorative covering for inflating the interior portion of the decorative covering.

16. The inflatable decorative covering of claim 1, wherein the decorative covering is configured to entirely enclose the lighting device therein.

17. The inflatable decorative covering of claim 1, wherein the exterior portion is integral with the interior portion.

18. A lighting device comprising the inflatable decorative covering of claim 1.

19. An inflatable apparatus configured to resemble an object related to a theme for decorating a lighting device, the inflatable apparatus comprising an inflatable portion configured for installation over the lighting device.

20. The apparatus of claim 19, wherein the inflatable portion includes a passage configured for receiving at least a portion of the lighting device therein.

21. The apparatus of claim 20, further comprising at least one fastener for securing the inflatable portion of the apparatus to the lighting device.

22. The apparatus of claim 21, wherein the fastener comprises a flap connected to the inflatable portion.

23. The apparatus of claim 20, further comprising at least one fastener for securing the inflatable portion of the apparatus to a secondary surface or structure.

24. The apparatus of claim 19, wherein the inflatable portion includes an exterior cover and an interior portion, the interior portion being configured to receive fluid for inflating the apparatus.

25. The apparatus of claim 19, wherein the inflatable portion resembles the object related to the theme when inflated.
